(19) United States
(12) Patent Application Publication
(10) Pub. No.: US 2005/0078936 A1
(43) Pub. Date: Apr. 14, 2005

(54) MEMORY CARD FOR DIGITAL TELEVISION DECODER AND METHOD OF PROCESSING DATA USING MEMORY CARD AND METHOD OF RENTAL OF MEMORY CARDS

(75) Inventors: Patryk CHARYDCZAK, Wilkanowo (PL); Jan NIZIOLEK, Zielona Gora (PL); Gracjan GORAK, Zielona Gora (PL)

Correspondence Address: SCHOLL PATENT AGENCY, INC.;DR. MATTHIAS SCHOLL, 800 MAIN ST, #308, HOLDEN, MA, 01520, US

(73) Assignees: ADVANCED DIGITAL BROADCAST POLSKA SP. Z O.O., Zielona Gora (PL); ADVANCED DIGITAL BROADCAST LTD., Hsin-Tien City (TW)

(21) Appl. No.: 10/711,813

(22) Filed: Oct. 6, 2004

(30) Foreign Application Priority Data
Oct. 10, 2003 (PL) P-362782

(51) Int. Cl. H04N 5/76; G06F 9/30; G06F 9/40; G06F 15/00

(52) U.S. Cl. 386/46; 386/124

(57) ABSTRACT

The present invention relates to a memory card (201) for a digital television decoder, which has a memory block (202) with a separate data memory area (205). The separate data memory area (205) can have the size from ten megabytes to a few gigabytes and can be used for storing audio/video data, audio data or application programs for the digital television decoder. The card also comprises a conditional access circuit (207) for descrambling of data stored in the separate data memory area (205), and a controller (206) for controlling the data flow inside the card. The controller (206) allows replay of data from the separate data memory when the conditions for replay of data, stored separately for each data file, are met.

### CROSS-REFERENCE TO RELATED APPLICATIONS

This application claims priority to Polish Application No. P-362782, filed Oct. 10, 2003, the contents of which are incorporated herein by reference.

### BACKGROUND OF THE INVENTION

1.) Field of the Invention

The present invention relates to a memory card for a digital television decoder and a method of processing data using a memory card as well as a method of rental of memory cards.

2.) Brief Description of the Background of the Invention Including Prior Art

The PCMCIA standard defines a physical interface for electronic cards, which can be used to provide additional functionality to electronic devices. For example, PCMCIA-type cards with embedded conditional access system (in short, CA cards) are used in digital television decoders (commonly called set-top boxes) to descramble the received television signal. These cards may have a logical interface compliant with the DVB (Digital Video Broadcast) Custom Interface or the POD (Point of Deployment) Custom Interface. There are also known PCMCIA-type cards with embedded large-capacity data memory (for example, Flash memory), especially used with personal computers.

There is a computerized advertisement broadcasting system known from the American patent application No. US 2001/0013131. The system comprises a console and memory cards, on which advertising programs are stored in MPEG format. The advertising program can be broadcast repetitively by the console to the television set. However, the card used in the system does not include conditional access circuits for signal descrambling and a data access controller.

There is a digital recording and reproducing system with copy protection known from the European patent application No. 0954173. The system comprises recording means for recording scrambled digital data and means for processing billing information related to the recorded data. The recommended recording means are a magnet-optical disk, a DVD-RAM or a hard disk, which have the drawback that they require the recording device (for example, a digital television decoder) to be equipped with additional interface, which significantly increases the cost of the system. Moreover, the system for scrambling data is different from the conditional access system used for descrambling the received signal, which increases the system complexity. In addition, the system does not allow controlling the amount of reproduced data.

There are a method and a device for recording and reproducing television programs known from the European patent application No. 1185097. The method utilizes a memory card containing television program reservation information, which activates a recording device to record specified programs to the memory card. However, said memory card does not include conditional access circuits for signal descrambling and does not include a data access controller.

There is also a wireless communication point of deployment module for use in digital cable compliant devices known from the American patent application No. 2002/0157115. The module comprises memory for storing application programs for the device. However, the module does not contain any data access controller.

There is a smart card digital video recorder system known from the American patent application No. 2003/0026589. The smart card is equipped with a processor and a storage device, and can be used for recording a data stream from a receiving device into which the smart card is inserted. However, this smart card does not employ any data access controller.

There is a PC card recorder known from the American patent application No. 2003/0059047. It employs a PC card for recording and playback of programming data, where the card comprises means for descrambling of the received signal and filtering out information that is not necessary for storing. However, it does not include any data access controller

### SUMMARY OF THE INVENTION

Purposes of the Invention

It is an object of this invention to provide a memory card for a digital television decoder that allows storing data, the access to which is controlled according to conditions for replay of data.

It is another object of this invention to provide a method of processing data using a memory card, on which the data are stored.

It is still another object of this invention to provide a method of easy rental of memory cards.

These and other objects and advantages of the present invention will become apparent from the detailed description, which follows.

### BRIEF DESCRIPTION OF THE INVENTION

A memory card for a digital television decoder, according to the present invention, comprises an interface for communication with a decoder, a conditional access circuit, a memory block having a separate data memory area for recording data and a controller for controlling a transfer of data between the conditional access circuit and the memory block and for controlling a flow of data directly between the memory block and the interface allowing communication with the decoder.

Data in the memory block can be stored in form of files. A header of each of the files can contain fields, which identify the file and define conditions for replay of the file.

The field defining the conditions for replay of the file can describe an allowed number of file replays, an internal activation code, a replay size condition, a time of last replay of the file and the number of executed replays.

The fields, which identify the file, can describe a file identifier, a file type, extended information about the file and additional information.

Data, stored on the separate data memory area, can be related to a program application for the digital television decoder and/or to audio/video data and/or to audio data.

In a method of processing data in a digital television decoder, equipped with a memory card, containing an interface for communication with the decoder, a conditional access circuit and a memory block, according to the present invention, a separate data memory area is set in the memory block, where data in form of files is stored, each file having a header with information identifying the file and conditions for replay of the file, and the conditions for replay are checked before replay of the data. The replay of the data is allowed when the conditions of replay are met.

At recording data it is checked if the data, which are to be recorded, have specified conditions for replay and if the conditions are specified, the conditions are stored in the file header, and if the conditions are not specified, the default conditions are stored in the file header.

The card can communicate through a PCMCIA interface of the decoder.

In case of lack of space for recording data, a list of data for removal is presented to the user, and next after the user selects specific data, they are removed from the memory and the attempt to record data is resumed.

When a list of data for removal is presented to the user, the data whose removal will free the required space in memory, is highlighted.

The list of data presented for removal can be arranged according to the number of executed replays.

At storing, information identifying the file, the file identifier, the file type, extended information about the file and additional information can be stored.

At storing, information identifying the conditions for replay of the file, the allowed number of file replays, the internal activation code, the replay size condition, the time of last replay of the file and the number of executed replays can be stored.

Before replay of data a decision is made to replay data from the beginning or from the time of last replay.

During data replay the amount of the replayed data is compared with the file replay size condition and when the size of the replayed data exceeds the file replay size condition, the number of executed file replays is increased by one.

After the data replay is stopped, information about the time of last replay of the file is recorded in the file header.

The allowed number of file replays can be modified after entering the external activation code matching the internal activation code.

The data stored in the data memory area are related to program applications for the digital television decoder and/or audio/video data and/or audio data.

In a method of rental of memory cards with films, according to the present invention, the conditions of a card rental are set before the rental of the memory card, they are recorded on the card, and while using the card, the number of executed film replays are recorded, and after the return of the memory card the number of executed film replays is read and the time of a card rental is defined and the rental fee is calculated according to an algorithm. The conditions of card rental can be predefined.

The rental fee can depend on the type of the film, production date, viewing rate, special offers for particular films, the number of executed film replays and rental time.

The novel features, which are considered as characteristic for the invention are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the accompanying drawings one of the possible embodiments of the present invention is shown, where:

FIG. 1 shows a schematic diagram of a digital television decoder;

FIG. 2 shows a structure of a memory card;

FIG. 3 shows the structure of a digital television decoder provided with a memory card;

FIG. 4 shows a structure of files recorded on the memory card;

FIG. 5 shows contents of the memory card;

FIG. 6 shows a flow chart of a procedure of reading data;

FIG. 7 shows a flow chart of procedure of recording data;

FIG. 8 shows a flow chart of a procedure of modification of allowed number of replays;

FIG. 9 shows a system for rental of cards;

FIG. 10 shows a flow chart of a procedure of a rental of cards;

FIG. 11 shows a flow chart of a procedure of handling and billing at returning of the memory card.

### DESCRIPTION OF INVENTION AND PREFERRED EMBODIMENT

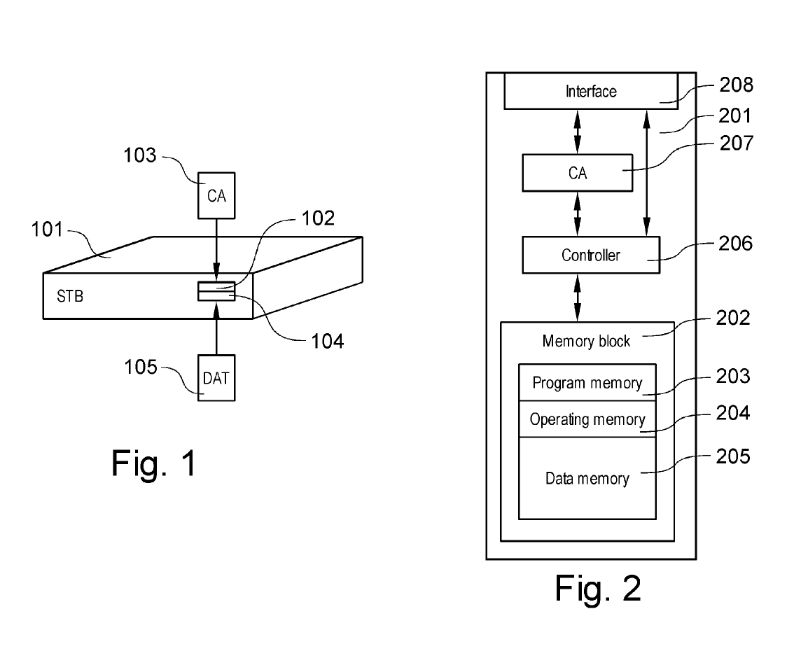

The digital television decoder 101 shown in FIG. 1 has two readers (slots) of CA cards. Preferably, the first reader 102 can be used for a typical CA card 103 used for descrambling of the received television signal. The second reader 104 can be used for a memory card 105.

In an alternative embodiment, the decoder can be equipped with only one CA card reader. Then, a single memory card 105 with a CA circuit is enough to descramble the currently received television signal and store programs requested by the user.

FIG. 2 represents the structure of a memory card 201. The card 201 has a memory block 202, which can be for example a Flash memory or a combination of Flash memory for application programs 203 and for data memory 205, as well as random access memory as an operating memory 204. The program memory 203 is used for storing the software used by a controller 206 and a conditional access (CA) block 207. The operating memory 204 is used for software execution. The data memory 205 is used for recording of scrambled data. The size of the data memory 205 may depend on the application of the card and the type of stored data. For example, a card designed for storing games would have the data memory of the size of a few megabytes. A card designed for recording video programs would have the data memory of the size of more than ten megabytes, a few hundreds of megabytes or even a few gigabytes. The controller 206 controls the access to the memory, the CA block 207 is responsible for descrambling data read from the memory, and the interface 208 is responsible for communication with the digital television decoder.

In an alternative embodiment, the controller 206 and the CA block 207 can have their own, separate memory blocks.

The flow of data inside the card depends on the card operation mode. If it is the operation mode of a typical CA card (i.e. the card is used only for descrambling data received by the decoder), the scrambled data from the decoder are transmitted through the interface 208 to the CA block 207, where the data are descrambled. The descrambled data are sent back from the CA block 207, through the interface 208, to the decoder. In the CA block 207 the data can be additionally scrambled by means of a specific algorithm. Such data flow is typical to CA cards.

The operation mode of data recording involves a different data flow routine. When new data is to be stored on the card, information on that data is transmitted through the interface 208 to the controller 206. This information allows the controller to create a data file in the memory 205 and store information on the stored data in the file header. The controller checks if there is a possibility of data recording and sends appropriate information to the decoder. Next, the scrambled data from the decoder are transmitted through the interface 208 to the CA block 207 and to the controller 206, which directs these scrambled data to the appropriate place in the data memory 205.

In the operation mode of data reading, the decoder may send to the controller 206, through the interface 208, a request for information about data available on the card. Then, the controller 206 collects the requested information from the data memory 205 from files headers, and sends them through the interface 208 to the decoder. The decoder may also send to the controller 206, through the interface 208, a request for reading a specific file. Then, after checking that the requested file can be read, the controller 206 collects the data of the requested file from the data memory 205 and sends it to the CA block 207, where the data is descrambled. Next, after optional scrambling by means of a custom algorithm, the data is sent through the interface 208 to the decoder.

As mentioned above, the data sent by the CA block are descrambled, and next optionally scrambled by means of a custom algorithm. The additional scrambling may be dependent on the system specification and the logical interface of the card. The additional scrambling may increase security of the data and allows reading of the data only by a decoder supporting the specific scrambling algorithm.

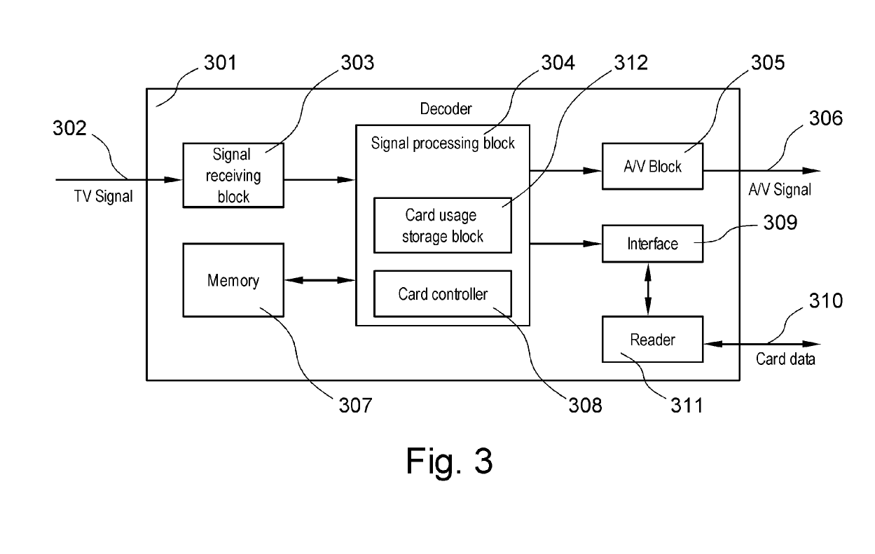

The structure of the digital television decoder 301 utilizing the memory card is shown in FIG. 3. A television signal stream is received by a signal receiving block 303, and it is processed in the signal processing block 304. Next it is converted in the audio/video block 305 to the A/V signal 306 acceptable by the television receiver connected to the decoder. The signal receiving block utilizes a memory block 307. The memory block 307 can contain random access operating memory and Flash type data memory 308, for application programs executed in the decoder. The application programs of the signal processing block include an application for communicating with the memory card, i.e. the card controller 308. The memory block also comprises a block 312 for storing information about card usage. The card controller exchanges data 310 with the card through the interface 309 after the card is placed in the reader 311, and the block for recording information 312 about card usage registers the data about the current usage of the card. If the card is in the operation mode of a typical CA card, the decoder sends to the card a scrambled television signal stream and receives a descrambled stream therefrom. If the card is in the operation mode of data reading, the decoder reads data from the card memory. If the card is in the operation mode of data recording, a scrambled stream is sent from the decoder and recorded in the card memory. Moreover, if the decoder is capable of processing two data streams, one of the received streams can be sent to the audio/video block for displaying on the television receiver, and the second to the memory card for recording. Similarly, when the decoder is capable of processing two data streams, one stream may be sent to the card for recording, while the second one may be read from the card memory. This allows time shifting functionality or recording one program while replaying another one.

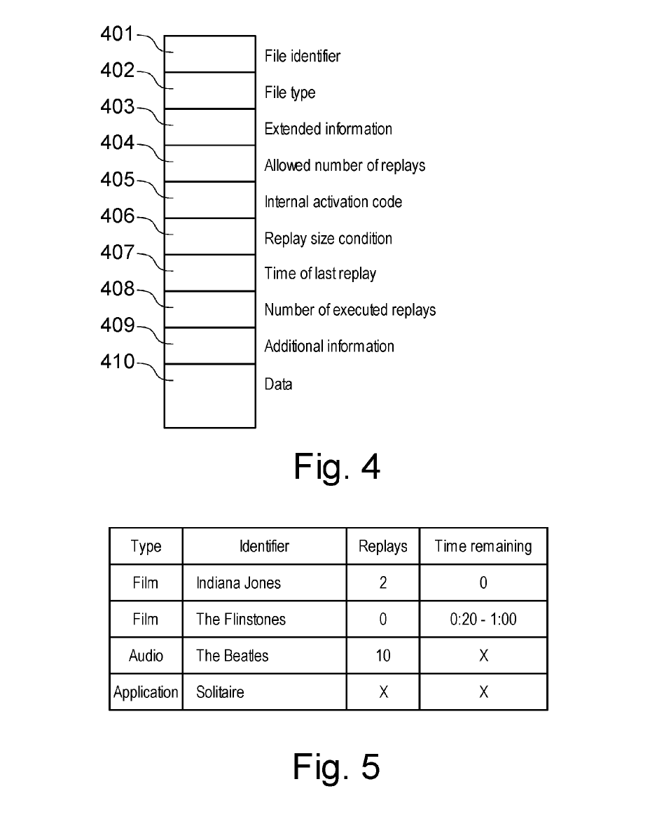

Data is stored in the card memory in form of files. The exemplary structure of the file is presented in FIG. 4. The file contains a header and a data part. The header contains various information fields. The file identifier field 401 defines, for example, a film title. The file type field 402 informs if the data is audio/video stream, audio stream or application program data. The extended information field 403 may contain a short description of a film, information about actors and a director. The field 404 informs about the allowed number of file replays. The field 405 defines the internal activation code, which allows changing the field of the allowed number of file replays. The field 406 defines the replay size condition, i.e. the condition on which the number of executed file replays is increased. The field 407 stores the amount of data, which was replayed during the last file replay, i.e. it defines the executed time of last replay. The number of executed file replays is recorded in the field 408. The field 409 contains additional information on the file, such as information recorded by the card producer or data supplier. The header fields 401-409 are followed by a data section 410. The fields 401 and 402 are commonly used in memory cards, while the fields 403 to 409 are specific for the embodiment of this invention. The replay size condition field 406 can specify the percentage of the file content that must be read for the file to be acknowledged as replayed (for example, 10% for audio/video data, and 100% for application programs). Alternatively, it can specify the amount of data (for example, the amount of data which corresponds to replay of 10 minutes of audio/video stream). The time of last replay field 407 specifies the amount of data, replayed from the time of the last increase of the field of the number of executed replays. Therefore, a user, who replayed a part of the file greater than the replay size condition, and next stopped the replay, has a possibility of replaying it from the place, where it was last stopped.

The presented system allows the user to preview the contents of the card before selecting a specific program to be read. The card contents can be presented in form of a table, shown in FIG. 5.

The columns of the table represent information about the type of data, the identifier (for example, a film name), the remaining number of replays (i.e. the difference between the allowed number of replays and the number of executed replays), and the time, which remains from the time of last replay.

The rows of the exemplary table represent:
“Indiana Jones” film, which was replayed recently in whole or has not been replayed yet, which can be replayed two times more,
“The Flintstones” film, which was recently replayed by 20 minutes, and its remaining part can sill be replayed, from the time 0:20 to the time 1:00, while the limit of replays from the beginning has already expired,
the audio album “The Beatles”, which does allow to set the time remaining for listening, and the user can listen to it 10 more times,
an application program—the “Solitaire” game, with no functionality of time remaining for reading, and which can be replayed any number of times.

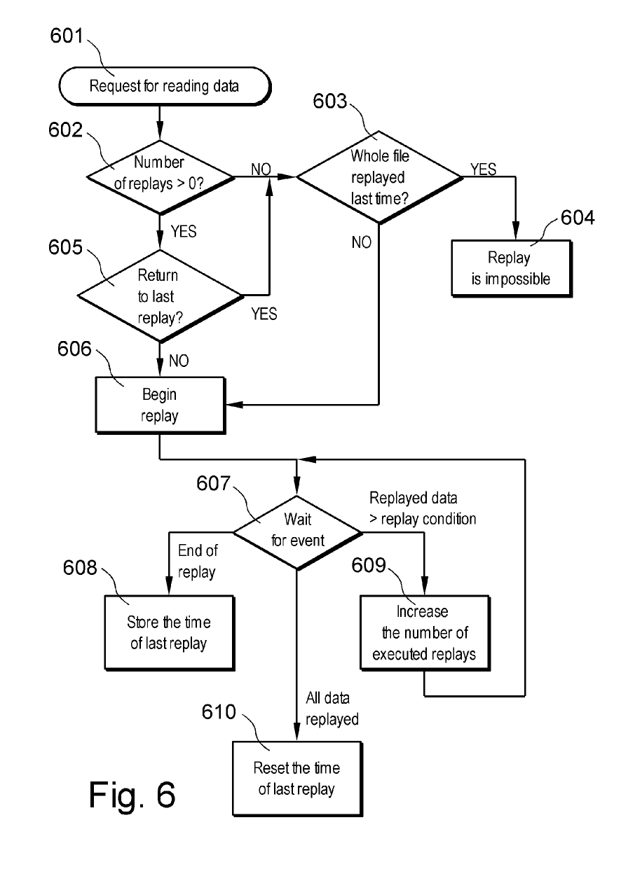

FIG. 6 shows the procedure of reading data requested by the user. The procedure is activated by a request for data reading in step 601. In step 602 it is checked if the number of remaining replays (i.e. the difference between the allowed number of replays and the executed number of replays) of the selected file is greater than zero. If not, in step 603 it is checked if the whole file was replayed at the last replay, by analyzing the value of the time of last replay field of the file header. If the whole file was replayed last time, a message is displayed in step 604. If the allowed number replays is greater than zero, the user is asked in step 605, whether to play the file from the beginning, or from the moment of the time of last replay.

Next, the file is replayed from the selected position in step 606. While replaying the file, the procedure awaits for an event in step 607. If the amount of data replayed becomes greater than the replay size condition, , the value of the number of executed replays is increased by one in step 609, and the procedure awaits for a next event. If the user stops the replay, the current replay time is recorded as the time of the last replay in step 608. If the whole file was replayed, the time of the last replay is reset, so that the next replays are started from the beginning of the file.

In case when the allowed number of replays of the file is unlimited, like in the “Solitaire” game from FIG. 5, the procedure jumps from step 601 directly to step 606.

In case, when the time remained from the last replay of the file is not defined, like in the “Solitaire” game or the audio album “The Beatles” from FIG. 5, the procedure jumps directly from step 602 to step 604 or 606. When the whole file is replayed or the user stops the replay, no additional actions can be made with the file.

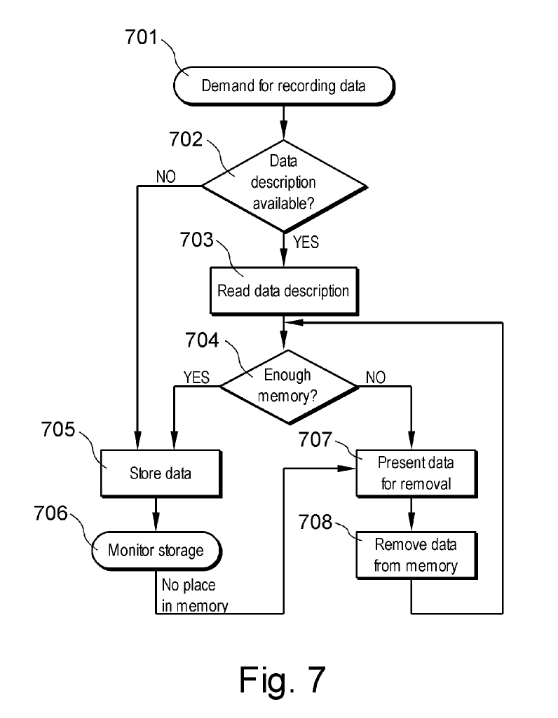

The procedure of recording data is shown in FIG. 7. It is activated in step 701 by a request for data recording sent by the decoder. Then it is checked in step 702 if there is any description available about the data being recorded, for example, specific PSI/SI (Program Specific Information/Service Information) data in the MPEG stream, which can define the length of the program, contents description, actors or data access information (for example, allowed number of replays and replay size condition). If so, the description is read in step 703. The length of the program is used in step 704 to predict the size of the file and check if there is enough space in the memory. If there is enough space, data recording is started in step 705. Data recording is monitored in step 706. A file is created and the description read in step 703 is recorded in the file header. If there is no data description available, default values are written in the file header. For example, the default allowed number of replays can be unlimited.

Then the procedure monitors the process of data recording. In case the memory becomes full (or it is close to full), the user is asked in step 707, which data should be removed from the memory. The procedure may highlight (for example, by an icon or different font color) the data whose removal will free the required space in memory. The data may be also arranged according to the number of executed replays, so that the user may select first the programs, which were already watched. The user may either select specific data (not necessarily the distinguished files) or stop recording the current program. The selected data are removed in step 708, and the procedure returns to step 704 to check if there is enough space in the memory for recording the current data.

Depending on the card usage, it may become necessary to modify the allowed number of replays of the recorded data. For example, in case of programs with a limited allowed number of replays broadcast in a television signal an additional activation code could be bought to increase the allowed number of replays by a specific number. If the card is used by a rental store for films or games, the employee of the store can increase the allowed number of replays, to rent the film to another client.

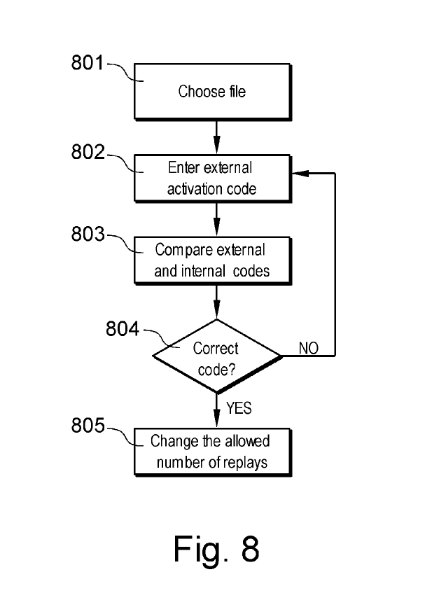

The procedure of modification of allowed number of replays is shown in FIG. 8. It starts in step 801 with a selection of the file whose allowed number of replays is to be modified. Next, in step 802, an external activation code is entered. This code can be entered manually by the user or automatically recorded by the digital television decoder or activating device in the rental store. In step 803 the entered code is compared with the internal activation code, stored in the file, and in step 804 it is checked if the given external activation code is correct. If the code is correct, the allowed number of replays field is changed in step 805 to a value defined by the entered code. The external code can define setting a specific allowed number of replays or increasing it by a specific number.

The internal activation code can be a general code or a code dependent on the serial number of the memory card or the specific decoder. This prevents the use of one code by many users. The external and internal codes can be identical or can be a pair of private and public keys, with a specific scrambling algorithm. The external code can be generated dynamically, so that double entry of the same code does not modify the allowed number of replays. The code's value can be time-dependent. The code can also have a specific expiry date, e.g. 3 days. The code can be typed in by the user or automatically fetched from the television signal.

The presented memory card can be used for recording audio/video data (films), audio data (music albums) and program applications for the decoder (utilities or games). The advantage of the card that the data are stored in a scrambled form and descrambled by the built-in CA circuit. This ensures security of data stored in the memory. The card can be used as a data carrier for the decoder, and data recorded on the card in one decoder can be replayed in another decoder, regardless of the CA circuit applied in it, providing that the logical interfaces of the card and the decoder are compatible.

Moreover, the advantage of the card is that it contains a controller of access to the data. The controller fetches information about the data from the file header. This information can include: the allowed number of replays, the activation code (which allows increasing the allowed number of replays), the replay size condition (which defines the size of data, after replay of which the number of executed replays will be increased) and information about the time of last replay (which allows replaying from the moment of the last stop).

The cards can also be used in rental stores, where the owner of the rental store at the time of renting a film, recorded on the card, can define the allowed number of the film replays and make the rental fee dependent on this number.

The rental fee can be also calculated after return of the card, on the basis of the data usage recorded on it.

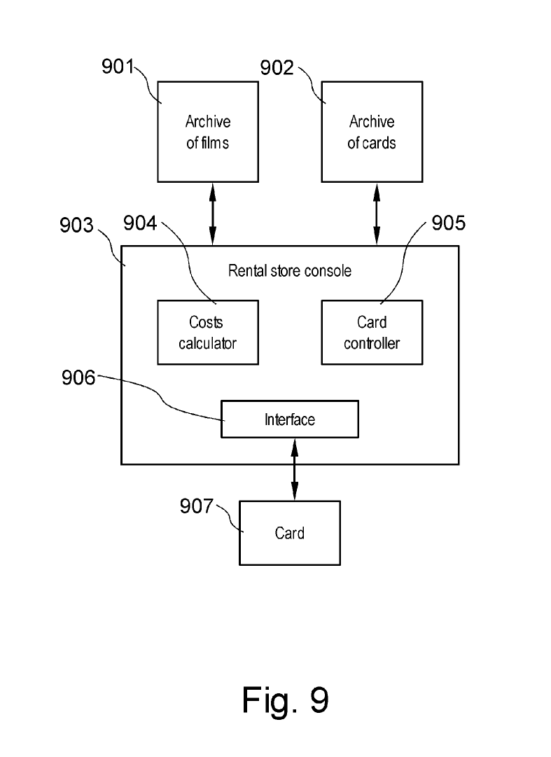

The system for rental of cards is shown in FIG. 9. Its main element is a rental store console 903, for example a PC-type computer. The console contains a card interface 906, i.e. a reader for cards 907. The important elements of the console software are the cost calculator 904 and the card controller 905. The console is connected with archive of films 901 and archive of recorded cards 902, which can be its integral parts or separate devices.

The cost calculator 904 is responsible for calculating the cost of card rental, which in case when the card contains films, can depend on the type of the film, production date, viewing rate, special offers for particular films, the number of executed film replays. The card controller interacts with the card through the interface 906 and it is used to handle the header of the file to be recorded or read. When a film is rented to a client, the controller records the film description and its conditions for replay. When the client returns the card, the controller checks the number of executed replays of the film and checks if the card is not damaged. The archive of films 901 comprises mass storage with films. For example, it can be an array of CDs, DVDs or hard disks, containing the data collection. The archive can be also connected to a high-bandwidth network, from which additional films can be fetched. The archive of cards 902 contains information about cards that are already recorded and currently available in the rental store depository.

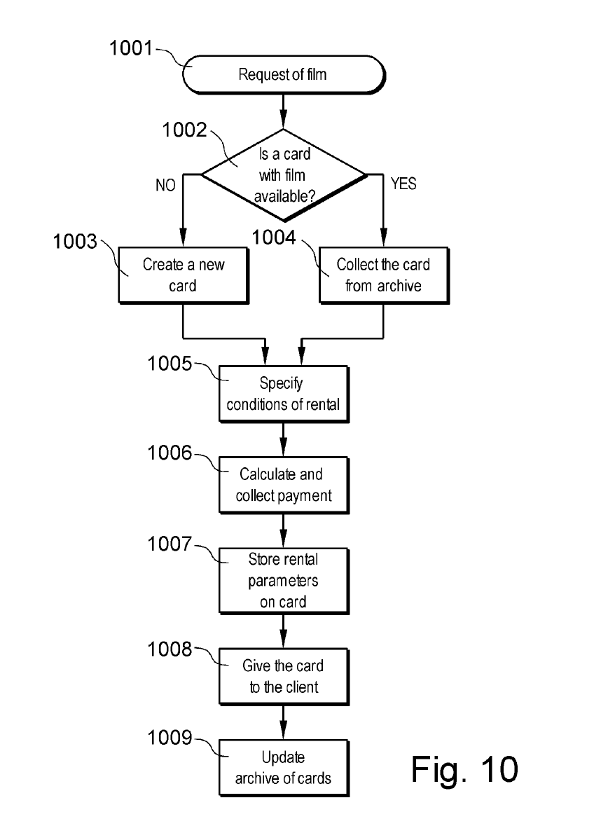

FIG. 10 presents a method for rental of cards. After a request of a film is received in step 1001, it is checked in step 1002 in the archive of cards, if there is a card available with the requested film. If so, the card is fetched from the depository in step 1004. If there is no card available, a new card with the film is created in step 1003. The new card is created by reading the film data from the archive of films and recording it on a blank card. Next, the conditions of card rental are defined. The user can select two payment options: a predefined allowed number of replays (for example, only one replay allowed), or a delayed payment that is calculated for the number of executed replays.

In the first case the allowed number of replays 404 from FIG. 4 is set to the number required by the user. In the second case, the field of the allowed number of replays is set as inactive, and the number of executed replays will be recorded in the field 408 from FIG. 4.

Next, the rental fee is calculated (depending on the number of executed replays and rental time) and collected in step 1006 (alternatively, it can be collected in after the return of the card). Next, in step 1007 the conditions of card rental are recorded on the card in the file header. Next, the card is given to the client in step 1008 and information is updated in the cards archives in step 1009, by storing information that the card has been rented and is not available in the depository.

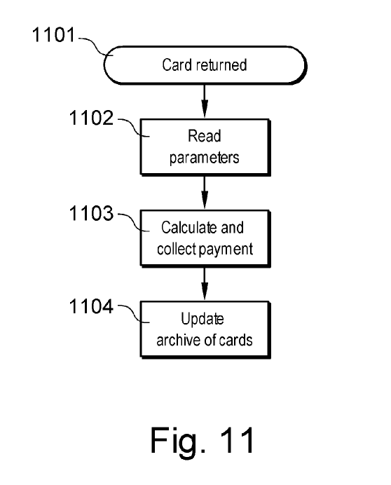

FIG. 11 presents a method for handling the return of the card and billing. After the card is returned, in step 1101, it is placed in the card reader and its parameters are read from the film header in step 1102. For example, the allowed number of replays and the number of executed replays can be read when the user selected the option of a delayed payment for the number of the executed replays. It is also checked if the card is not damaged. Next, on the basis of the read information a fee is calculated and collected in step 1103—an additional fee may be collected or a prepaid amount may be returned (deposit for the card or the sum for the number of replays not executed). In step 1104 the archive of cards is updated by storing information that the card is returned and available in the depository.

The above description may serve for developing similar methods of card rental, such as renting several films on one card (for example a set of fairy tales for children or a set of movies).

The preferred embodiment having been thus described, it will now be evident to those skilled in the art that further variation thereto may be contemplated. Such variations are not regarded as a departure from the invention, the true scope of the invention being set forth in the claims appended hereto.

1. A memory card for a digital television decoder comprising
an interface for communication with a decoder;
a conditional access circuit;
a memory block having a separate data memory area for recording data; and
a controller for controlling a transfer of data between the conditional access circuit and the memory block and for controlling a flow of data directly between the memory block and the interface for communication with the decoder.

2. The card according to claim 1, wherein data in the memory block are stored in form of files wherein a header of each of the files contains fields, which identify the file and define conditions for replay of the file.

3. The card according to claim 2, wherein the field defining the conditions for replay of the file describes an allowed number of file replays, an internal activation code, a replay size condition, a time of last replay of the file and the number of executed replays.

4. The card according to claim 2 wherein the fields, which identify the file, describe a file identifier, a file type, extended information about the file and additional information.

5. The card according to claim 1, wherein data, stored on the separate data memory area are related to a program application for the digital television decoder.

6. The card according to claim 1, wherein data stored on the separate data memory area are related to audio/video data.

7. The card according to claim 1, wherein data recorded on the separate data memory area are related to audio data.

8. A method of processing data in a digital television decoder, equipped with a memory card, containing an interface for communication with the decoder, a conditional access circuit and a memory block comprising the steps of:
setting a separate data memory area in the memory block;
storing data in form of files in the data memory area, each file having a header with
information identifying the file and conditions for replay of the file;
checking the conditions for replay before replay of the data; and
allowing to replay the data when the conditions for replay are met.

9. The method according to claim 8, wherein at recording data it is checked if the data, which are to be recorded have specified conditions for replay and if the conditions are specified, the conditions are stored in the file header, and if the conditions are not specified, the default conditions are stored in the file header.

10. The method according to claim 8, wherein the card communicates through a PCMCIA interface of the decoder.

11. The method according to claim 8, wherein in case of lack of space for recording data, a list of data for removal is presented to the user, and next after the user selects specific data, they are removed from the memory and the attempt to record data is resumed.

12. The method according to claim 11, wherein when a list of data for removal is presented to the user, the data whose removal will free the required space in memory, is highlighted.

13. The method, according to claim 12, wherein the list of data presented for removal is arranged according to the number of executed replays.

14. The method according to claim 8, wherein at storing information identifying the file, the file identifier, the file type, extended information about the file and additional information are stored.

15. The method according to claim 8, wherein at storing information identifying the conditions for replay of the file, the allowed number of file replays, the internal activation code, the replay size condition, the time of last replay of the file and the number of executed replays are stored.

16. The method according to claim 12, wherein before replay of data a decision is made to replay data from the beginning or from the time of last replay.

17. The method according to claim 14, wherein during data replay the amount of the replayed data is compared with the file replay size condition and when the size of the replayed data exceeds the file replay size condition, the number of executed file replays is increased by one.

18. The method according to claim 14, wherein after the data replay is stopped, information about the time of last replay of the file is recorded in the file header.

19. The method, according to claim 14, wherein the allowed number of file replays is modified after entering the external activation code matching the internal activation code.

20. The method according to claim 8, wherein the data stored in the data memory area are related to program applications for the digital television decoder.

21. The method according to claim 8, wherein the data stored in the data memory area are related to audio/video data.

22. The method according to claim 8, wherein the data stored in the data memory area are related to audio data.

23. A method of rental of memory cards with films comprising the steps of:
settling conditions of a card rental before the rental of the memory card;
recording conditions of a card rental on the card;
recording the number of executed film replays while using the card;
reading the number of executed film replays after the return of the memory card; and
defining the time of a card rental and calculating the rental fee according to an algorithm.

24. The method of rental of memory cards according to claim 23, wherein the conditions of card rental are predefined.

25. The method of rental of memory cards according to claim 23, wherein the rental fee depends on the type of the film, production date, viewing rate, special offers for particular films, the number of executed film replays and rental time.
